(19) United States
(12) Patent Application Publication
(10) Pub. No.: US 2026/0336947 A1
(43) Pub. Date: Oct. 29, 2026

(54) CONVEYING APPARATUS

(71) Applicant: ISUZU MOTORS LIMITED, Yokohama-shi (JP)

(72) Inventor: Hidemi SASAKI, Fujisawa-shi (JP)

(21) Appl. No.: 19/464,750

(22) Filed: Jan. 30, 2026

(30) Foreign Application Priority Data
Mar. 6, 2025 (JP) 2025-035511

(51) Int. Cl. B65G 47/244; B65G 47/06; B65G 47/82

(52) U.S. Cl. CPC B65G 47/244; B65G 47/06; B65G 47/82; B65G 2201/02

(57) ABSTRACT

A conveying apparatus includes a through-hole portion that penetrates the rotating body, an insertion member that moves a plurality of battery cells arranged in a first orientation so as to insert the plurality of battery cells into the through-hole portion, when the rotating body is in the first state, a restricting unit that restricts movement of the plurality of battery cells inserted into the through-hole portions, a rotation control unit that rotates the rotating body from the first state to the second state, to displace the plurality of battery cells from the first orientation to a second orientation rotated by the predetermined angle, and a pushing member that pushes out the plurality of battery cells in the second orientation from the through-hole portion when the rotating body is in the second state.

### CROSS-REFERENCE TO RELATED APPLICATIONS

The present application claims priority to Japanese Patent Applications number 2025-35511, filed on Mar. 6, 2025 contents of which are incorporated herein by reference in their entirety.

### BACKGROUND OF THE INVENTION

The present disclosure relates to a conveying apparatus for conveying battery cells.

Japanese Unexamined Patent Application Publication No. 2020-188004 discloses a conveying apparatus configured to convey battery cells to be inspected. The conveying apparatus includes a conveyor configured to convey the battery cells, and an inspection stage to which the battery cells are transferred from the conveyor, and transfers laterally oriented battery cells from the conveyor to the inspection stage.

In conveying apparatuses, there is a demand to change the arrangement direction of a plurality of battery cells. For example, in order to place a plurality of battery cells arranged in a vertical orientation in a housing portion onto a conveyor, it is necessary to change an orientation of the battery cells to a lateral orientation.

However, in the above-described conveying apparatus, the battery cells are rotated while maintaining the lateral orientation, and therefore it is difficult to change the arrangement direction of the battery cells.

### BRIEF SUMMARY OF THE INVENTION

The present disclosure focuses on this point, and an object thereof is to facilitate changing an arrangement direction of a plurality of battery cells.

An aspect of the present disclosure provides a conveying apparatus including a rotating body that has a first state and a second state rotated by a predetermined angle from the first state, a through-hole portion that penetrates the rotating body so as to be orthogonal to an axial direction of the rotating body, an insertion member that moves a plurality of battery cells arranged in a first orientation so as to insert the plurality of battery cells into the through-hole portion, when the rotating body is in the first state, a restricting unit that is movable between a standby position separated from the through-hole portion and a proximity position adjacent to the through-hole portion, and restricts movement of the plurality of battery cells inserted into the through-hole portions when positioned at the proximity position, a rotation control unit that rotates the rotating body from the first state to the second state while the restricting unit is positioned at the proximity position, to displace the plurality of battery cells from the first orientation to a second orientation rotated by the predetermined angle, and a pushing member that pushes out the plurality of battery cells in the second orientation from the through-hole portion when the rotating body is in the second state.

### BRIEF DESCRIPTION OF THE DRAWINGS

FIG. 1 schematically shows a configuration of a conveying apparatus 1 according to an embodiment.

FIG. 2 schematically shows a configuration of an orientation changing unit 10.

FIG. 3 schematically shows a state in which an insertion member 30 adsorbs the battery cell 90.

FIG. 4 schematically shows a state in which the battery cell 90 is inserted into a through-hole portion 25.

FIG. 5 schematically shows a state in which a rotating body 20 is rotated to a second state.

FIG. 6 schematically shows a state in which a pushing member 40 pushes out the battery cell 90.

FIG. 7 schematically shows an operation of the orientation changing unit 110 according to the modification.

FIG. 8 schematically shows an arrangement of the battery cells 90 in the housing portion 103.

### DETAILED DESCRIPTION OF THE INVENTION

Hereinafter, the present disclosure will be described through exemplary embodiments of the present disclosure, but the following exemplary embodiments do not limit the disclosure according to the claims, and not all of the combinations of features described in the exemplary embodiments are necessarily essential to the solution means of the disclosure.

### Overview of conveying apparatus

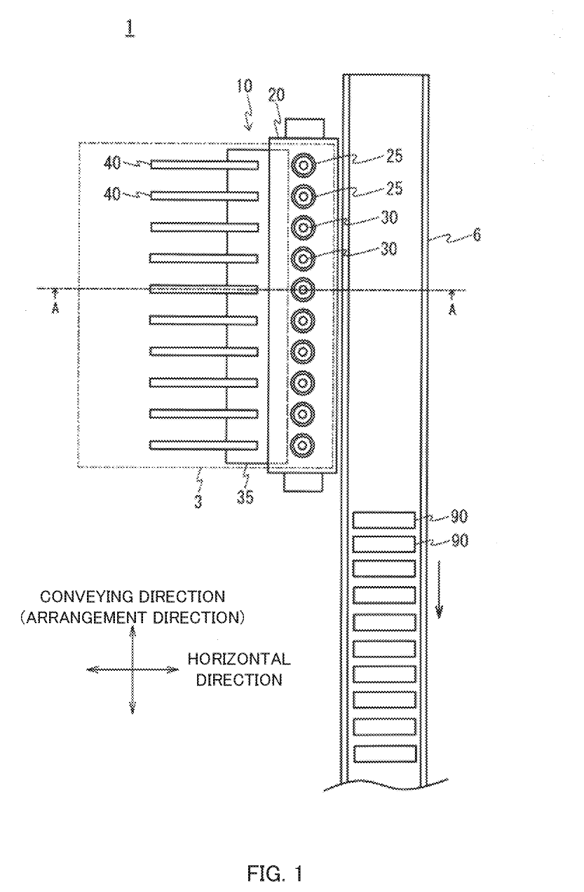

FIG. 1 schematically shows a configuration of a conveying apparatus 1 according to an embodiment. FIG. 1 shows the conveying apparatus 1 viewed from above.

The conveying apparatus 1 is an apparatus that conveys a plurality of battery cells 90 in a conveying direction. The conveying apparatus 1 is provided in a manufacturing line for assembling a battery pack from the plurality of battery cells 90, for example. The conveying apparatus 1 includes a housing portion 3, a conveying belt 6, and an orientation changing unit 10.

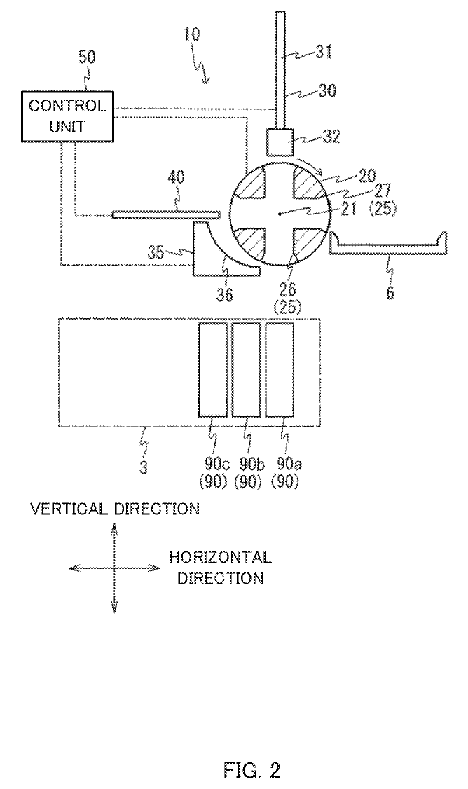

The housing portion 3 houses the plurality of battery cells 90 (see FIG. 2). The plurality of battery cells 90 in the housing portion 3 are arranged in a first orientation. The plurality of battery cells 90 are arranged in a vertical orientation (specifically, an orientation parallel to the vertical direction shown in FIG. 2) as the first orientation. The plurality of battery cells 90 are arranged in the housing portion 3 at predetermined intervals in the arrangement direction parallel to the conveying direction. For example, ten battery cells 90 are arranged at predetermined intervals in the arrangement direction. Specifically, ten of the battery cells 90a, 90b, and 90c shown in FIG. 2 are provided along the arrangement direction (the depth direction in FIG. 2).

The conveying belt 6 conveys the plurality of battery cells 90 housed in the housing portion 3 in the conveying direction. The conveying belt 6 conveys the battery cell 90 in a second orientation. The second orientation of the battery cell 90 is a lateral orientation (specifically, an orientation parallel to a horizontal direction shown in FIG. 1). The conveying belt 6 conveys the plurality of battery cells 90 to an inspection unit provided downstream in the conveying direction, for example. In the inspection unit, the battery cell 90 is inspected.

The orientation changing unit 10 changes the orientation of the battery cells 90 when moving the plurality of battery cells 90 housed in the housing portion 3 onto the conveying belt 6. Specifically, the orientation changing unit 10 changes the orientation of the battery cell 90 that is in the first orientation in the housing portion 3 to the second orientation, and moves the battery cell 90 onto the conveying belt 6. Here, the orientation changing unit 10 collectively changes the orientation of the ten battery cells 90 arranged in the arrangement direction into the second orientation and moves them onto the conveying belt 6. Accordingly, it is possible to facilitate collectively changing the arrangement direction of the plurality of battery cells 90 and moving the battery cells 90 onto the conveying belt 6.

### Detailed configuration of orientation changing unit

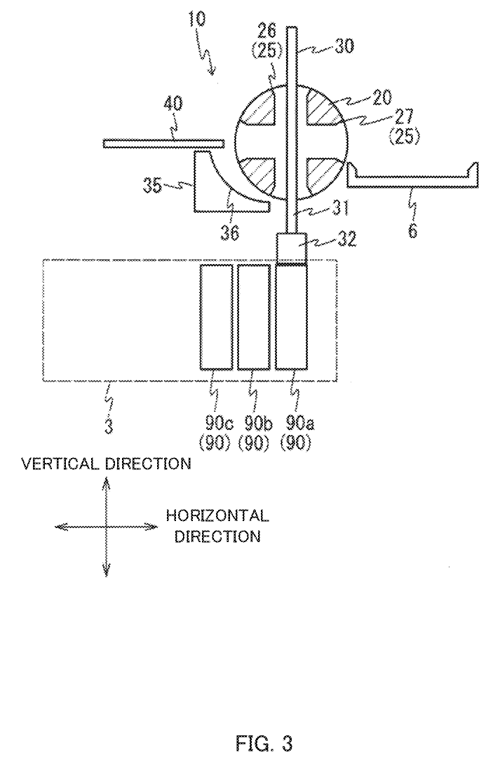

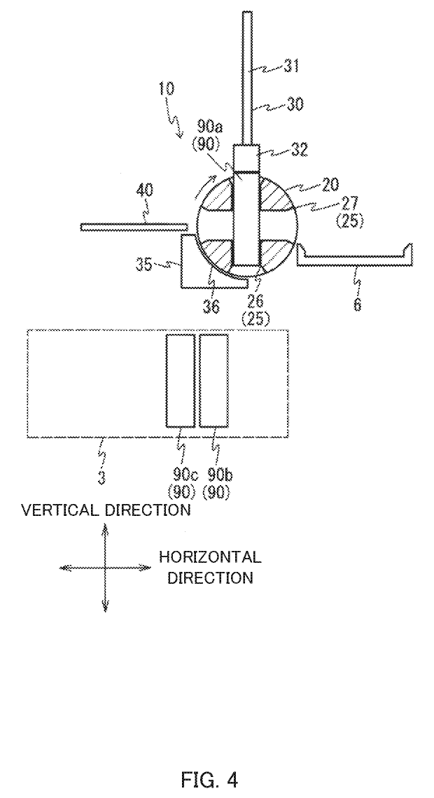

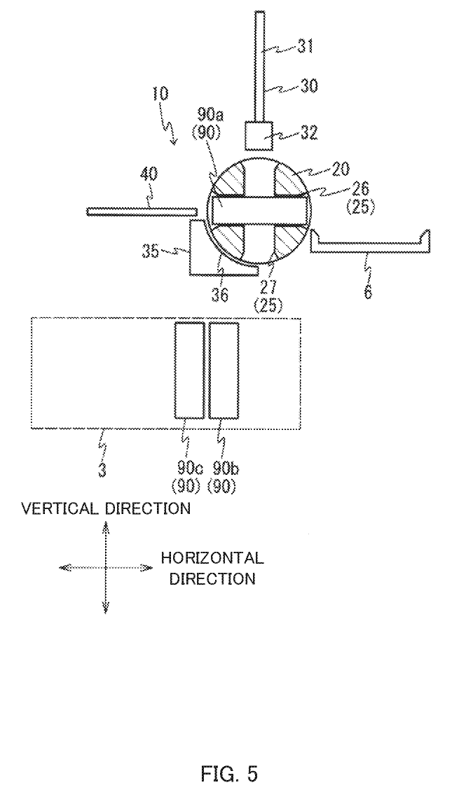

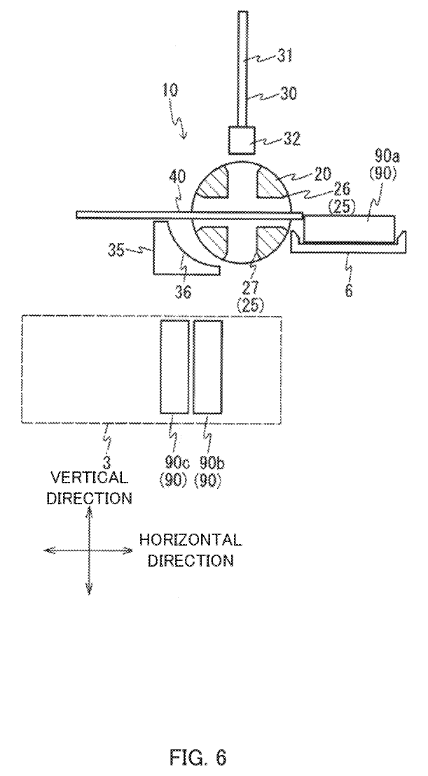

FIG. 2 schematically shows a configuration of the orientation changing unit 10. FIG. 3 schematically shows a state in which an insertion member 30 adsorbs the battery cell 90. FIG. 4 schematically shows a state in which the battery cell 90 is inserted into a through-hole portion 25. FIG. 5 schematically shows a state in which a rotating body 20 is rotated to a second state. FIG. 6 schematically shows a state in which a pushing member 40 pushes out the battery cell 90. It should be noted that FIG. 2 shows a view taken along line A-A in FIG. 1.

As shown in FIG. 2, the orientation changing unit 10 includes the rotating body 20, the through-hole portion 25, the insertion member 30, a restricting unit 35, the pushing member 40, and a control unit 50.

The rotating body 20 is provided alongside the conveying belt 6. The rotating body 20 is adjacent to the conveying belt 6 at the same height in the vertical direction. The rotating body 20 has a cylindrical shape as an example. An axial direction of the rotating body 20 is parallel to the conveying direction of the conveying belt 6. The rotating body 20 is located above the housing portion 3 in the vertical direction.

The rotating body 20 rotates about a rotation axis 21. The rotation axis 21 is parallel to the depth direction of the sheet of FIG. 2. Here, the rotating body 20 rotates clockwise about the rotation axis 21. An end portion of the rotating body 20 in the axial direction is coupled to a drive source (for example, a motor) that rotates the rotating body 20. The rotating body 20 stops when rotating clockwise by a predetermined angle.

The rotating body 20 has a first state and a second state rotated by the predetermined angle from the first state. For example, the rotating body 20 in the first state shown in FIG. 2 is rotated clockwise by 90 degrees to be in the second state shown in FIG. 5. In the present embodiment, in the rotating body 20 that rotates in 90-degree increments, a stopped state of the rotating body 20 before rotation corresponds to the first state, and a stopped state of the rotating body 20 after rotation corresponds to the second state.

The through-hole portion 25 is a hole portion penetrating the rotating body 20. The through-hole portion 25 penetrates the rotating body 20 so as to be orthogonal to the axial direction of the rotating body 20. The through-hole portion 25 may be formed so as to intersect a first direction and a second direction orthogonal to the axial direction. As shown in FIG. 1, a plurality of through-hole portions 25 are provided at predetermined intervals in the axial direction of the rotating body 20.

The through-hole portion 25 is a cross-shaped through hole as an example, and has a first hole portion 26 and a second hole portion 27 as shown in FIG. 2. The first hole portion 26 is a through hole parallel to the first direction (the vertical direction in FIG. 2), and the second hole portion 27 is a through hole parallel to the second direction (the horizontal direction in FIG. 2). The first hole portion 26 and the second hole portion 27 are cylindrical through holes. The inner diameters of the first hole portion 26 and the second hole portion 27 are slightly larger than the outer diameter of the cylindrical battery cell 90.

It should be noted that the through-hole portion 25 has the first hole portion 26 and the second hole portion 27 in the above description, but the present disclosure is not limited thereto. For example, the through-hole portion 25 may include only the first hole portion 26.

The insertion member 30 has a function of moving the battery cell 90 housed in the housing portion 3 upward, to insert the battery cell 90 into the through-hole portion 25. When the rotating body 20 is in the first state, the insertion member 30 moves the plurality of battery cells 90 arranged in the first orientation so as to insert the battery cells 90 into the through-hole portion 25.

The insertion member 30 is provided directly above the rotating body 20. As shown in FIG. 1, the number of insertion members 30 corresponds to the number of the through-hole portions 25, and the insertion members 30 are provided at predetermined intervals along the axial direction of the rotating body 20. Each of the plurality of insertion members 30 moves and inserts a single battery cell 90 into the through-hole portion 25. The insertion member 30 includes a moving unit 31 and an adsorbing unit 32.

The moving unit 31 is formed in a shaft shape and moves in a direction orthogonal to the axial direction of the rotating body 20 (specifically, the vertical direction). The moving unit 31 is connected to a driving mechanism and is moved in the vertical direction by the driving mechanism. The moving unit 31 moves in the vertical direction so as to be inserted into the through-hole portion 25 when the rotating body 20 is in the first state. Specifically, the moving unit 31 moves between a spaced position (FIG. 2) separated above the rotating body 20 and a contact position (FIG. 3) at which the adsorbing unit 32 contacts the battery cell 90 housed in the housing portion 3.

It should be noted that when the moving unit 31 is positioned at the contact position, the moving unit 31 is inserted through the through-hole portion 25 as shown in FIG. 3.

The adsorbing unit 32 is a unit that adsorbs the battery cell 90, and is an adsorbing pad, for example. The adsorbing unit 32 is provided at a distal end of the moving unit 31, and moves in the vertical direction together with the moving unit 31. The adsorbing unit 32 is connected to a suction mechanism via a tube through which air flows, for example. When the moving unit 31 is positioned at the contact position, the suction mechanism sucks air, so that the adsorbing unit 32 adsorbs an upper surface of the battery cell 90.

The insertion member 30 moves the battery cell 90 adsorbed by the adsorbing unit 32 into the through-hole portion 25. Specifically, as shown in FIG. 4, the insertion member 30 moves to an insertion position where the battery cell 90 is inserted into the through-hole portion 25. The insertion position is a position between the spaced position and the contact position. When the insertion member 30 is positioned at the insertion position and air suction by the suction mechanism is released, the adsorbing unit 32 no longer adsorbs the battery cell 90.

The restricting unit 35 restricts the movement of the battery cell 90 in the through-hole portion 25. For example, the restricting unit 35 restricts the battery cell 90, immediately after being inserted into the through-hole portion 25 by the insertion member 30, from falling downward in the vertical direction. Specifically, the restricting unit 35 contacts a lower surface of the battery cell 90 that is no longer adsorbed by the adsorbing unit 32 and supports the battery cell 90 so as not to fall downward.

The restricting unit 35 is movable between a standby position (FIG. 2) separated from the through-hole portion 25 and a proximity position (FIG. 4) adjacent to the through-hole portion 25. The standby position and the proximity position are separated from each other in the horizontal direction. The restricting unit 35 positioned at the proximity position restricts the movement of the battery cell 90 inserted into the through-hole portion 25. That is, the restricting unit 35 supports the lower surfaces of the plurality of battery cells 90 when positioned at the proximity position.

The restricting unit 35 is formed along an outer peripheral surface of the rotating body 20. Specifically, a facing surface 36 of the restricting unit 35 facing the outer peripheral surface of the rotating body 20 is a curved surface having a predetermined curvature. Accordingly, the restricting unit 35 restricts the movement of the battery cell 90 in the radial direction orthogonal to the axial direction of the rotating body 20 when the rotating body 20 rotates from the first state to the second state. In other words, the restricting unit 35 restricts outward radial movement of the battery cell 90 caused by the centrifugal force accompanying rotation of the rotating body 20. Accordingly, the battery cell 90 can be positioned in the through-hole portion 25 even when the rotating body 20 rotates while the battery cell 90 is not held by the rotating body 20.

The pushing member 40 pushes out the battery cell 90 in the through-hole portion 25. The pushing member 40 pushes out the plurality of battery cells 90 in the second orientation from the through-hole portion 25 when the rotating body 20 is in the second state (FIG. 5). Specifically, as shown in FIG. 6, the pushing member 40 pushes out the plurality of battery cells 90 in the second orientation onto the conveying belt 6.

The pushing member 40 is provided on the opposite side of the conveying belt 6 in the horizontal direction when viewed from the rotating body 20. As shown in FIG. 1, the number of the pushing members 40 corresponds to the number of the through-hole portions 25, and the pushing members 40 are provided at predetermined intervals along the axial direction of the rotating body 20. Each of the plurality of pushing members 40 is formed in a shaft shape, and a distal end portion of the pushing member 40 pushes out the battery cell 90. The pushing member 40 moves between a standby position and a push-out position in the horizontal direction. The standby position is a position separated from the rotating body 20. When the rotating body 20 rotates, the pushing member 40 is positioned at the standby position. The push-out position is a position where the pushing member 40 is inserted into the through-hole portion 25 to push out the battery cell 90 onto the conveying belt 6.

In the above description, the plurality of through-hole portions 25 are provided at predetermined intervals in the axial direction of the rotating body 20, but the present disclosure is not limited thereto. For example, the spacing in the axial direction between the plurality of through-hole portions 25 may be reduced, such that adjacent through-hole portions 25 (the first hole portion 26 and the second hole portion 27) may be connected to each other. In this case, the plurality of insertion members 30 and the plurality of pushing members 40 may each have an integrated structure formed as connected rectangular parallelepipeds, and may be configured to be inserted through the connected through-hole portions 25.

The control unit 50 controls an operation of the orientation changing unit 10. The control unit 50 is a Central Processing Unit (CPU), for example. The control unit 50 functions as a rotation control unit that controls the rotation of the rotating body 20.

The control unit 50 rotates the rotating body 20 from the first state to the second state while the restricting unit 35 is positioned at the proximity position to displace the plurality of battery cells 90 from the first orientation to the second orientation rotated by the predetermined angle. Specifically, the control unit 50 rotates the rotating body 20, having the plurality of battery cells 90 with restricted movement, from the first state to the second state rotated by 90 degrees to displace the plurality of battery cells 90 from the first orientation to the second orientation (FIG. 5). Accordingly, the orientation of the plurality of battery cells 90 can be collectively changed.

The control unit 50 controls movements of the insertion member 30, the restricting unit 35, and the pushing member 40. Specifically, the control unit 50 moves the insertion member 30 between the spaced position and the contact position, moves the restricting unit 35 between the standby position and the proximity position, and moves the pushing member 40 between the standby position and the push-out position. Further, the control unit 50 also controls the suction of air by the suction mechanism.

### Example of operation of orientation changing unit

An operation example of the orientation changing unit 10 will be described with reference to FIGS. 2-6. The operation of the orientation changing unit 10 is executed in accordance with an instruction from the control unit 50.

Here, it is assumed that the orientation changing unit 10 is in the state shown in FIG. 2. That is, in the first state in which the rotating body 20 is stopped (here, the first hole portion 26 of the through-hole portion 25 is vertically oriented), the insertion member 30 is positioned at the spaced position, the restricting unit 35 is positioned at the standby position, and the pushing member 40 is positioned at the standby position. A change in orientation of a single battery cell 90 will be described below, however, in practice, the orientation of the plurality of battery cells 90 arranged in the depth direction of the sheet of FIG. 2 is simultaneously changed by the orientation changing unit 10.

First, the control unit 50 moves the insertion member 30 from the spaced position to the contact position. That is, the control unit 50 inserts the insertion member 30 into the first hole portion 26 of the through-hole portion 25 to bring the adsorbing unit 32 into contact with the battery cell 90a arranged vertically in the housing portion 3 as shown in FIG. 3. Then, the control unit 50 operates the suction mechanism to cause the adsorbing unit 32 to adsorb the battery cell 90a.

Next, the control unit 50 moves the insertion member 30 that is adsorbing the vertically oriented battery cell 90a upward from the contact position and positions the insertion member 30 at the insertion position as shown in FIG. 4. As a result, the battery cell 90a is inserted into the first hole portion 26.

Subsequently, the control unit 50 moves the restricting unit 35 from the standby position to the proximity position. That is, the control unit 50 moves the restricting unit 35 in the horizontal direction to be positioned at the proximity position as shown in FIG. 4. Next, the control unit 50 stops the operation of the suction mechanism, and releases the state in which the adsorbing unit 32 is adsorbing the battery cell 90a. Then, the battery cell 90a in the first hole portion 26 tends to move downward, but is supported by the restricting unit 35 positioned at the proximity position.

Thereafter, the control unit 50 moves the insertion member 30 from the insertion position to the spaced position. Then, the control unit 50 rotates the rotating body 20 in the first state clockwise by 90 degrees to the second state (the first hole portion 26 is oriented laterally). As a result, the orientation of the battery cell 90a in the first hole portion 26 becomes lateral as shown in FIG. 5. It should be noted that the control unit 50 positions the restricting unit 35 at the proximity position when the rotating body 20 is rotating from the first state to the second state. As a result, even if the battery cell 90a tends to move outward due to the centrifugal force accompanying the rotation of the rotating body 20, the restricting unit 35 restricts such movement.

In a subsequent step, the control unit 50 moves the pushing member 40 from the standby position to the push-out position. As the pushing member 40 moves, the battery cell 90a in the first hole portion 26 moves onto the conveying belt 6 as shown in FIG. 6. That is, the control unit 50 pushes the battery cell 90a in the first hole portion 26 onto the conveying belt 6 by inserting the pushing member 40 into the first hole portion 26. As a result, the laterally oriented battery cell 90a is located on the conveying belt 6.

Next, the control unit 50 moves the pushing member 40 to the standby position and moves the restricting unit 35 to the standby position. Further, the control unit 50 moves the housing portion 3 so that the battery cell 90b is located directly below the second hole portion 27 of the rotating body 20. Then, by performing the operation described with reference to FIGS. 3-6, the control unit 50 changes the orientation of the battery cell 90b from the vertical orientation to the lateral orientation, and moves the battery cell 90b onto the conveying belt 6. That is, the control unit 50 rotates the rotating body 20 by 90 degrees in a state in which the battery cell 90b is inserted into the second hole portion 27, thereby changing the orientation of the battery cell 90b to the lateral orientation.

### Modification

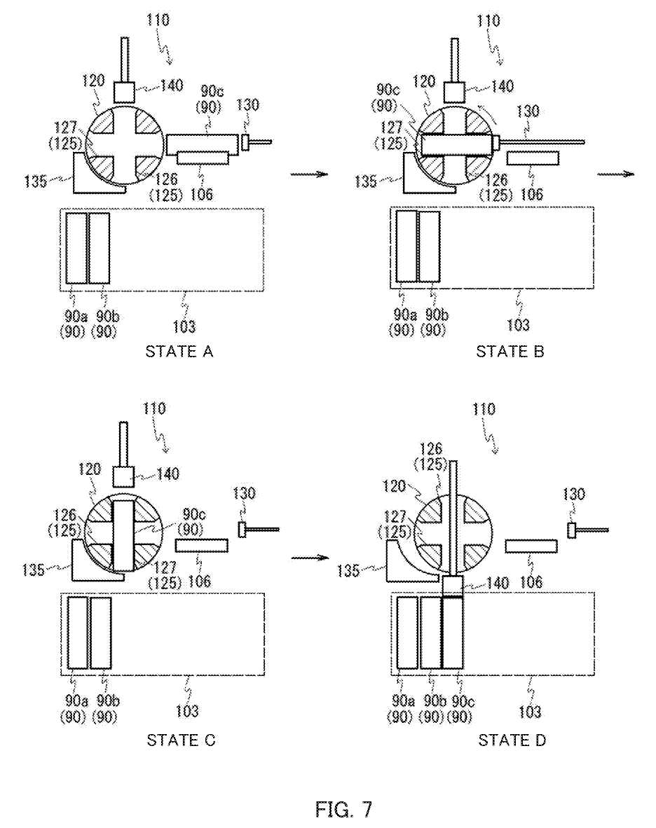

In the above description, the orientation changing unit 10 changes the orientation of the vertically oriented (first orientation) battery cell 90 arranged in the housing portion 3 to the lateral orientation (second orientation), and places the battery cell 90 on the conveying belt 6. In contrast, in the modification shown in FIG. 7, the orientation changing unit 110 changes the orientation of a laterally oriented (first orientation) battery cell 90 conveyed by a conveying belt 106 to the vertical orientation (second orientation), and houses the battery cell 90 in the housing portion 103.

FIG. 7 schematically shows the operation of the orientation changing unit 110 according to the modification. As shown in a state A, the orientation changing unit 110 includes a rotating body 120, a through-hole portion 125, an insertion member 130, a restricting unit 135, and a pushing member 140. Further, the orientation changing unit 110 includes the control unit 50 (FIG. 2) that operates the orientation changing unit 110. Since the configurations of the rotating body 120, the through-hole portion 125, and the restricting unit 135 are the same as those of the rotating body 20, the through-hole portion 25, and the restricting unit 35 described above, detailed description thereof will be omitted.

The insertion member 130 pushes the laterally oriented battery cell 90 on the conveying belt 106 so as to insert the battery cell 90 into a second hole portion 127 of the through-hole portion 125 of the rotating body 120 as shown in a state B. Since the insertion member 130 pushes the battery cell 90 in the horizontal direction, the adsorbing unit is not provided at a distal end of the insertion member 130. It should be noted that, also in the modification, the plurality of insertion members 130 are provided, and the plurality of insertion members 130 simultaneously insert the plurality of battery cells 90 on the conveying belt 106 into the second hole portions 127.

When the battery cell 90 is inserted into the second hole portion 127, the control unit 50 rotates the rotating body 120 by 90 degrees in the counterclockwise direction. At this time, the control unit 50 positions the restricting unit 135 at a proximate position adjacent to the rotating body 120. Accordingly, the orientation of the battery cell 90 inserted into the second hole portion 127 is changed to the vertical orientation as shown in a state C.

When the battery cell 90 in the second hole portion 127 is in the vertical orientation, the control unit 50 moves the pushing member 140 to a push-out position and moves the restricting unit 135 to a standby position. It should be noted that, also in the modification, the plurality of pushing members 140 are provided. As a result, the pushing members 140 simultaneously push the plurality of battery cells 90 in the second hole portions 127 downward, and the battery cells 90 are housed in the housing portion 103 as shown in a state D.

A plurality of through-hole portions 125 are provided similarly to the through-hole portions 25, and adjacent through-hole portions 125 may be connected to each other. In this case, the plurality of insertion members 130 and the plurality of pushing members 140 may each have an integrated structure formed as connected rectangular parallelepipeds, and may be configured to be inserted through the connected through-hole portions 125.

The orientation changing unit 110 according to the modification also performs the above-described operation to change the orientation of the laterally oriented battery cell 90 on the conveying belt 106 to the vertical orientation and house the battery cell 90 in the housing portion 103.

It should be noted that, in the modification, a movement mechanism that moves the orientation changing unit 110 in the depth direction of the sheet of FIG. 7 is provided. The moving mechanism positions the orientation changing unit 110 at a first position in the depth direction and at a second position that is displaced from the first position by a predetermined distance in the depth direction (for example, a distance corresponding to half a diameter of the battery cell 90).

The control unit 50 i) causes the battery cell 90, which is inserted into the first hole portion 126 and oriented vertically when the orientation changing unit 110 is positioned at the first position by the moving mechanism, to be housed in the housing portion 103, and ii) causes the battery cell 90, which is inserted into the first hole portion 126 and oriented vertically when the orientation changing unit 110 is positioned at the second position, to be housed in the housing portion 103.

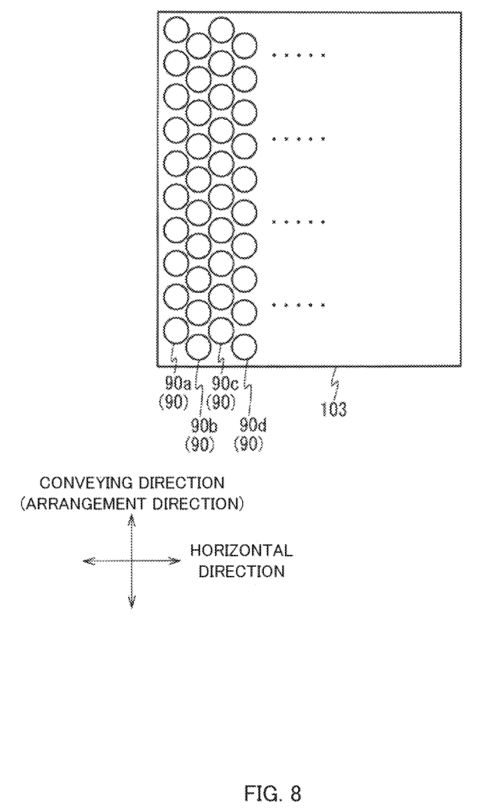

As a result, as shown in FIG. 8, the battery cells 90 are arranged in a triangular lattice shape in the housing portion 103. This enables the battery cells 90 in the housing portion 103 to be densely arranged. FIG. 8 schematically shows an arrangement of the battery cells 90 in the housing portion 103. FIG. 8 shows the battery cells 90 as viewed from above the housing portion 103.

### Effects of embodiment

The conveying apparatus 1 of the above-described embodiment includes the rotating body 20, the through-hole portion 25, the insertion member 30, the restricting unit 35, the pushing member 40, and the control unit 50, and changes the orientation of the battery cell 90 that is in the first orientation to the second orientation as the rotating body 20 rotates.

Accordingly, the orientation of the plurality of battery cells 90 arranged in the first orientation can be easily changed to the second orientation in a short time.

The present disclosure is explained on the basis of the exemplary embodiments. The technical scope of the present disclosure is not limited to the scope explained in the above embodiments and it is possible to make various changes and modifications within the scope of the disclosure. For example, all or part of the apparatus can be configured with any unit which is functionally or physically dispersed or integrated. Further, new exemplary embodiments generated by arbitrary combinations of them are included in the exemplary embodiments of the present disclosure. Further, effects of the new exemplary embodiments brought by the combinations also have the effects of the original exemplary embodiments.

1. A conveying apparatus comprising:
a rotating body that has a first state and a second state rotated by a predetermined angle from the first state;
a through-hole portion that penetrates the rotating body so as to be orthogonal to an axial direction of the rotating body;
an insertion member that moves a plurality of battery cells arranged in a first orientation so as to insert the plurality of battery cells into the through-hole portion, when the rotating body is in the first state;
a restricting unit that is movable between a standby position separated from the through-hole portion and a proximity position adjacent to the through-hole portion, and restricts movement of the plurality of battery cells inserted into the through-hole portions when positioned at the proximity position;
a rotation control unit that rotates the rotating body from the first state to the second state while the restricting unit is positioned at the proximity position, to displace the plurality of battery cells from the first orientation to a second orientation rotated by the predetermined angle; and
a pushing member that pushes out the plurality of battery cells in the second orientation from the through-hole portion when the rotating body is in the second state.

2. The conveying apparatus according to claim 1, wherein
the rotation control unit rotates the rotating body, having the plurality of battery cells with restricted movement, from the first state to the second state rotated by 90 degrees, to displace the plurality of battery cells from the first orientation to the second orientation.

3. The conveying apparatus according to claim 1, further comprising:
a conveying belt that conveys the battery cell in the second orientation, wherein
the pushing member pushes out the plurality of battery cells in the second orientation onto the conveying belt.

4. The conveying apparatus according to claim 1, wherein
the insertion member includes an adsorbing unit that adsorbs the battery cell, and
the insertion member moves the battery cell adsorbed by the adsorbing unit to the through-hole portion.

5. The conveying apparatus according to claim 4, wherein
the insertion member is provided with the adsorbing unit at its distal end, and
the insertion member further includes a moving unit that can be inserted through the through-hole portion when the rotating body is in the first state.

6. The conveying apparatus according to claim 1, wherein
the restricting unit is formed along an outer peripheral surface of the rotating body, and
the restricting unit restricts movement of the battery cell in a radial direction orthogonal to the axial direction of the rotating body when the rotating body rotates from the first state to the second state.

7. The conveying apparatus according to claim 1, wherein
the through-hole portion is a hole portion formed to intersect a first direction and a second direction orthogonal to the axial direction.

8. The conveying apparatus according to claim 1, wherein
the first orientation of the plurality of battery cells is an orientation parallel to a vertical direction, and
the second orientation of the plurality of battery cells is an orientation parallel to a horizontal direction.

9. The conveying apparatus according to claim 1, further comprising:
a conveying belt that conveys a battery cell in the first orientation, wherein
the insertion member pushes the plurality of battery cells that are on the conveying belt, to be inserted into the through-hole portion.
